(19) United States
(12) Patent Application Publication
(10) Pub. No.: US 2011/0256293 A1
(43) Pub. Date: Oct. 20, 2011

(54) Method for Making Legume-Based Dough and Nutritional Products Therefrom

(75) Inventors: Deepali Palta, Dallas, TX (US); Richard Todd Smith, McKinney, TX (US); James William Stalder, Dallas, TX (US)

(73) Assignee: FRITO-LAY NORTH AMERICA, INC., Plano, TX (US)

(21) Appl. No.: 12/763,278

(22) Filed: Apr. 20, 2010

(51) Int. Cl. A21D 13/00; A23P 1/10; A23L 1/01

(52) U.S. Cl. 426/550; 426/497; 426/438

(57) ABSTRACT

Legumes having a raw moisture content of between about 19% to about 45% are pressure cooked to a moisture content of between about 42% to about 49%. The legumes may also be subjected to a low thermal stress dewatering at less than about 160° F. After grinding, additional ingredients such as starches, fibers, protein, and/or vitamin and mineral fortification can be added prior to forming a legume-based dough. Kneaded or shaped dough can be cooked and seasoned to make a nutritious snack food comprising between about 5 and about 6 grams of protein per one ounce serving, or between about 10%-30% protein.

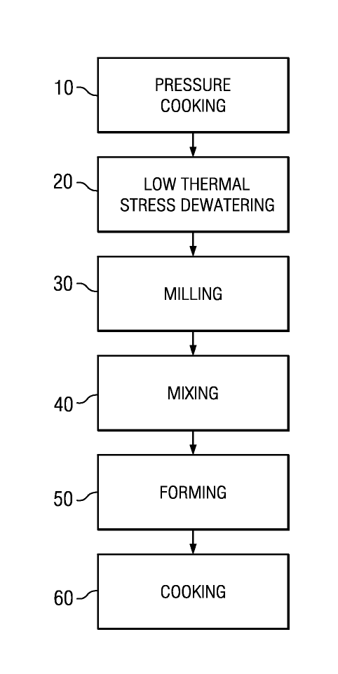

### BACKGROUND OF THE INVENTION

1. Technical Field

The present invention relates to the production of a sheetable dough made from raw legumes, which can be made into a variety of shelf stable snack foods with minimal reduction of organoleptical properties and substantial elimination of time and costs as well as the off-flavors associated with soy beans.

2. Description of Related Art

Legumes are known to be high in protein, fiber, and amino acids. Due to their nutritional values, a number of attempts have been made to incorporate legumes into ready-to-eat snack products. However, the majority of these processes require long cooking times in order to soften the tough skin of the legume. Long soaking and cooking times can result in the loss of the dietary fiber and protein contained in the hull, and the need for additional absorbed moisture requiring additional processing to remove moisture, affecting both the consistency of a dough product and the nutritional content of the end product. In addition, products made from whole soybeans typically have certain “grassy” or “beany” off-flavors and odors, for which prior art methods have not been successful in controlling or eliminating the flavorants to minimize the problem.

Various attempts have been made to incorporate legume proteins into snack food products. U.S. Pat. Nos. 6,291,009 and 6,479,089 disclose a soy based dough and products made from the dough, using either derivatives of roasted or toasted soybeans such as full fat soy flour or other soy flour, or soy protein concentrates or isolates, which result in a product having inferior nutritional qualities. Further, soy protein concentrate and soy protein isolates are astringent and do not break down during mastication forcing the consumer to continue to feel the need to chew for a longer period of time. Thus, it is desirable to minimize use of soy protein isolates and soy protein concentrates as ingredients because of poor mouth feel (mouth-drying) and texture attributes. Further, soy protein concentrates and soy isolates are relatively expensive compared to unprocessed raw ingredients. For example, soy protein isolates and soy protein concentrates can cost ten times or more the cost of raw soybeans. Moreover, full fat soy flour and other soy flours are typically produced from whole soybeans that have been solvent extracted and heat treated (e.g. toasted and roasted) to deactivate enzymes and trypsin inhibitors, and then milled. As a result, full fat soy flour and other soy flours usage at high levels similarly produce products with poor mouth feel, texture and flavor attributes.

U.S. Pat. No. 4,601,910 discloses a soybean cooking process wherein soybeans are softened by soaking and cooking the soybeans in selected fruit juice additives. However, this process remains timely, requiring soaking and cooking steps ranging from at least half an hour and up to five and a half hours. U.S. Pat. No. 3,142,571 discloses extracting expanded soy protein products with hot water to leach out undesirable flavors, but provides for only a bland resulting product.

There is therefore a need in the art for a time-efficient method for manufacturing ready-to-eat, nutritious snack products from plant-based proteins such as raw legumes. Such a method should provide for a high amount of protein using cost-efficient foods, while producing a product free of undesired off-flavors typically associated with raw legumes. The method should also allow for the manufacturing of a wide array of products, including, nutritional supplements and nutritious snack foods such as bars, cookies, and crackers, while minimizing the need for other dry ingredients that may not otherwise contribute to nutritional qualities. The legume-based snack foods should emulate the organoleptical properties, including taste and texture, of a conventionally produced snack product and should provide for a good source of protein such as a nutritionally complete soy protein in a shelf-stable form.

### SUMMARY OF THE INVENTION

The proposed invention provides a time and cost efficient method for manufacturing legume-based dough made from whole, unprocessed legumes as well as the snack products made from the dough. Generally, it has been found that by pressure-cooking legumes, an improved method of creating a legume-based sheetable dough is achieved, allowing for the manufacturing of a wide variety of ready-to-eat, shelf-stable snack foods having a good source of protein. Pressure cooking provides for significantly reduced cooking times as well as the elimination of a soaking step, which is typically required with some varieties of legumes and in particular, for hard beans and pulses. Surprisingly, it has been found that lower moisture contents of the legumes are achieved when compared to previous methods that soak legumes for long periods of time under atmospheric pressure. This is particularly beneficial when preparing legume-based dough as it provides for a desirable reduction in the amount of processed dry ingredients needed in order to create a sheetable dough. This reduces not only costs, but also any potential off-flavors.

Low thermal stress dewatering, preferably utilizing temperatures below 160° F., can be used to further reduce the moisture content of the pressure-cooked legumes before mixing the legumes with other ingredients to form a sheetable dough. The dough can be kneaded for forming and subsequent cooking to create nutritious food products having at least five grams of protein. The method can be easily modified to provide for a number of nutritious products ranging from snacks high in protein to nutritional supplements capable of nourishing undernourished populations. The food product can be seasoned at any point during the process, whether before or after cooking. The resulting products will accept a wide range of both topical and internal flavors. Hence, this invention produces a shelf-stable, ready-to-eat food product comprising at least 5 grams of protein with a final moisture content of less than 3%. The above as well as additional features and advantages of the present invention will become apparent in the following written description.

### BRIEF DESCRIPTION OF THE DRAWING

The novel features believed characteristic of the invention are set forth in the appended claims. The invention itself, however, as well as a preferred mode of use, further objectives and advantages thereof, will be best understood by reference to the FIGURE, which depicts a flow chart diagram of one embodiment of the present invention.

### DETAILED DESCRIPTION

As used herein, a suitable “legume” is meant to refer to a raw, whole, unprocessed legume having a native protein content ranging from about 19% to about 45% protein on a dry weight basis and includes only native legumes isolated from a natural plant source. Suitable legumes can be commercially acquired from any number of manufacturers and include peas, soybeans, navy beans, black beans, red kidney beans, white kidney beans, lima beans, canary beans, fava beans, cranberry beans, lupins, garbanzo beans, mung beans, red lentils, green lentils, and pigeon peas. In particular, this method works well even for those varieties of beans that typically require long soaking times prior to cooking, often overnight, such as hard beans, for example chickpeas, soybeans, red kidney beans, white kidney beans, black beans, whole peas, lima beans and canary beans.

When using raw, whole, unprocessed legumes, long periods of soaking are typically required in order to soften the legumes before taking advantage of the nutrients within a legume. The softening of the legumes requires soaking in water or lime-water solution under atmospheric conditions for at least about 40 minutes and then subsequent boiling and cooking in a kettle for about 20 to 25 minutes. Further hours of soaking can also be necessary, depending on the legume, in order to obtain a desirable consistency for the creation of a kneadable dough.

Applicants have found that by pressure cooking legumes, an improved method of forming a legume-based dough is achieved, not only having reduced cooking times but also actually reducing the moisture content of the legumes as compared to previous methods of soaking under atmospheric conditions. This not only provides for some cost-efficiency, as fewer processed dry ingredients are necessary to manipulate the dough, but also allows for the incorporation of various nutrient-enriched ingredients. In addition, the method described herein performs better than a soaking step under atmospheric conditions because it entirely eliminates long soaking steps. In fact, it has been found that pressure-cooking significantly reduces cooking times by at least 83%, while resulting in a cohesive dough. Further, low thermal stress dewatering may provide for the preservation of desired nutrients for the creation of a wide range of food products having a range of beneficial nutritional qualities.

An embodiment of the present invention will now be discussed in further detail and with reference to the FIGURE. While the following description describes a batch process of pressure-cooking legumes, commercial large-scale pressure-cooking procedures can also be performed and could be easily determined by one skilled in the art, when armed with this disclosure.

In a first step, a plurality of legumes is placed in a bench top pressure cooker 10 with water sufficient to cover the legume food product. As used herein, pressure cooking is meant to refer a process wherein products are cooked in a sealed vessel that does not permit air or liquids to escape and is capable of producing a working pressure within the sealed vessel over the existing average atmospheric pressure at sea level (or about 1 atm or about 14.7 psi). Thus, as used herein the pressure is meant to refer to the pressure within the cooker relative to the surrounding atmosphere, also known as psig or psi. Suitable ranges for pressure cooking include between about 10 and about 15 psi.

In one embodiment, for every one cup of legumes used, between about 4 and 5 cups of waters is added. For example, in one embodiment, when about 1 cup of raw soybeans is used, about 4 cups of water is used, where the weight of one cup of soybeans is about 180 grams and the weight of water is about 910 grams. In another embodiment, about one cup of chickpeas (about 200 grams) and about 5 cups of water (about 1140 grams) is used.

The legumes are then pressure cooked at between about 10 and about 15 psi in one embodiment. In another embodiment, the legumes are pressure cooked at about 15 psi. A suitable pressure cooker may be found at any number of manufacturers. During test runs, a whistling pressure cooker manufactured by Hawkins was used, emitting a puff of steam and short 5 second whistle. This cooker operates with oscillating pressures, cycling through building pressure and then releasing it with a whistling sound of escaping steam. The cooker was fully pressurized after about 4 minutes, completing the first cycle and causing a loud blast of escaping steam that produced a sharp whistle. The heat was then reduced and after about 5 more cycles, or about 6 minutes later, the legumes were removed from the cooker for further processing. Thus, in one embodiment, the legumes are cooked and ready for further formation into a dough in as few as ten minutes. In another embodiment, the legumes are cooked in about 15 minutes. In a third embodiment, the legumes are cooked between about 10 and 15 minutes. With previous methods, this is generally achieved in at least one hour and often require hours or overnight soaking in some cases. This soaking typically results in the loss of the hull of the legumes, which contains desired nutritious qualities such as dietary fiber. Long soaking steps may also contribute to the release of off-flavors. Thus, there is a significant and beneficial reduction in time, while maintaining nutritional qualities intact.

Following the pressure-cooking step 10, the cooked legumes are then ground 20. While any method may be used for grinding, a cutter such as one manufactured by Urschel Laboratories, Inc. was used in test runs. Prior to grinding, the legumes may optionally also be decanted prior to transferring for grinding. The moisture content of the cooked, ground legumes ranges from about 42% to about 49% when pressured cooked for only 10 minutes at about 15 psi in a first embodiment. In a second embodiment, when pressure cooked for 15 minutes, the moisture content ranges from between about 53% to 59%. In another embodiment, cooked and ground soybeans comprise a moisture content of between 42% and 43%. In another embodiment, ground soybeans comprise a moisture content of about 49%. In another embodiment, cooked and ground chickpeas comprise a moisture content of between about 46% and 47%. Preferably, the moisture content remains below about 55%, as moisture contents above about 55% by weight can be difficult to sheet. Therefore, it has been found that pressure-cooking actually provides the benefit of producing manageable legume-based doughs without having to add more dry ingredients for the sole purpose of reducing the moisture content. Instead, one need only add water to produce a manageable legume-based dough.

In another embodiment, to decrease the moisture content after cooking, the legumes are subjected to a low thermal stress dewatering 30. As used herein, “low thermal stress dewatering” refers to the dehydration of the milled legumes using temperatures below about 160° F. so that nutrients may be preserved. In one embodiment, the low thermal stress dewatering is achieved by centrifugation. In another embodiment, the cooked soybeans may be passed through an oven set at temperatures below about 160° F. In another embodiment, microwave drying may be used.

Additional ingredients are then mixed with the legumes in a large mixer with a paddle 40, to form a legume-based dough 50 depending on the desired end product. In one embodiment, the admix may be combined together in the mixer prior to adding the ground soybeans. The admix of dry ingredients can comprise starch, proteins, fiber, wholegrains, seeds, vegetables, fruits, vitamins and/or minerals and mixtures thereof. For example, additional starch, sugars, fiber, protein, shortening, whole grains, seeds, vegetables, fruits, and vitamin and/or mineral supplements, and mixtures thereof. The starch can be selected from the group consisting of modified starches, pre-gelatinized starches, native starches, pre-gelatinized modified starches, and mixtures thereof. The fiber can be selected from the group consisting of oat fiber, bamboo fiber, potato fiber, corn bran, rice bran, wheat bran, resistant starches, inulin, and mixtures thereof. Additional protein can be selected from the group consisting of soy flour, soy meal, soy grits, soy chips, soy protein isolate, soy protein concentrate, whey proteins, milk proteins, and mixtures thereof. The whole grains include, but are not limited to, wheat berry, whole wheat, barley, and oats. The seeds can include, but are not limited to, sesame seeds, poppy seeds and flaxseed. Any dried or dehydrated vegetable such as dehydrated broccoli may be used. Similarly, any dried fruit may be used include for example, and without limitations, cranberry.

In one embodiment, byproducts of other manufacturing processes are admixed into the dough to improve taste or texture and further eliminate waste. For example, corn washings, potato starch, any excess oats or oatmeal and orange juice pulp remaining from the production of other food productions can be used. During test runs, a mineral premix comprised of Vitamins A and E, iron, zinc, and a combination or mixtures thereof was added. In one embodiment, in addition to the admix of dry ingredients, oil, including but not limited to, corn oil, cottonseed oil or sunflower oil can be added to help provide a cohesive dough. In one embodiment, the legume-based dough comprises between 0% and about 6% oil by weight. In another embodiment, the legume-based dough comprises about 5% oil. The resulting dough product comprises from about 5% to about 95% protein. In one embodiment, the dough comprises at least 45% of the cooked legumes in order to provide for a good source of protein. In one embodiment, the dough comprises between about 40% and 45% cooked legumes, about 5% oil, and between about 20% to about 30% starch.

Once the desired ingredients are added 40, the dough is formed or shaped 50. Water may be added to increase the moisture content of the dough to form more manageable dough. In one embodiment, between about 13% and about 14% water is added to form the dough 50 after adding the dry ingredients 40. In one embodiment, a dough comprises wet weight of between about 45% and 55% soybeans, between about 17% and about 30% starch, and about 13% of an additional protein. In one embodiment, the dough further comprises about 10% sugar by wet weight. The forming can be achieved as with any other snack product; for example, by kneading, sheeting, cutting or shaping. In one embodiment, the dough is rolled down to a desired thickness and cut. For example, in one embodiment, the dough is transferred to a double reduction sheeter, which sheets the dough. In one embodiment, the diameter of cut pieces is about 4 mm. The shaped pre-forms can then be sent to an oven for cooking 60. In one embodiment, the cooking step produces a shelf-stable snack food product having a moisture content of about 1.5%. In another embodiment, the cooking step produces a shelf-stable, snack food product having a moisture content of between about 0.8% and about 2.0%. More preferably, a moisture content of about 1.0% is achieved.

In one embodiment, the cooking step comprises using an oven at temperatures of about 250 F. In another embodiment, multiple ovens or zones are utilized ranging from about 300 F to about 450 F. For example, the dough may be transferred to an oven comprising four heat zones for a dwell time of about 2.2 minutes. A suitable oven is manufactured by APV. Zone one is set to about 450 F, zone two is set to about 425 F, zone three is set to about 350 F, and zone four is set to about 325 F. Upon exiting, the toasted dough pieces comprise a moisture content of about 8.5%. The toasted pieces are then transferred via conveyor belt to an air impingement oven for a dwell time of between five and six minutes, and more preferably about 5.5 minutes. Upon exiting, resulting crisps contain a moisture content of about 1.5% and are preferably seasoned. During one test run, the crisps were seasoned with a mixture of 10% by weight oil, 5% by weight Wasabi Ranch and 0.11% by weight of a pre-mix of vitamins A and E. A serving size of 1 oz (28 g/About 16 crisps) provides for about 5 grams of total fat content, about 5 grams of total carbohydrates, about 6 grams of protein, and about 128 calories.

In another embodiment wherein the dough comprises sugar, the dough is rolled into balls comprising a diameter of between about one and two inches. After slightly flattening, the dough products are sent to an oven set at about 250 F for a dwell time of about 80 minutes. Upon exiting, the resulting shortbread-type cookies may be seasoned. During one test run, the cookies were seasoned with a mixture of 3% by weight oil, 3% by weight powder sugar and 0.11% by weight of a pre-mix of vitamins A and E. A serving size of 1 oz (28 g/About 4 cookies) provides for about 6 grams of total fat content, about 14 grams of total carbohydrates, about 5 grams of protein, and about 133 calories.

There are a number of advantages provided by the present invention. First, the cooking time of the legumes is significantly reduced, entirely eliminating long soaking and cooking times. Second, existing food-processing equipment from a traditional corn tortilla chip line, including toast ovens, fryers, seasoning tumblers, and sheeting and baking platforms can be used in conjunction with a pressure cooker. Thus, in one embodiment, a food product manufacturer of corn tortilla chips can easily use existing equipment in making this legume-based dough. Third, there is a reduced risk of burning the beans, creating off-flavors, and a reduced risk of the loss of nutrition and flavor. Fourth, byproducts from other manufacturing lines can be incorporated into the snack products such that no overall food waste is experienced and as a result, less waste is dispensed and production costs are reduced while maintaining good nutritional levels in foods and creating a wide range of desirable good-tasting snacks capable of counteracting malnutrition. Fifth, the invention provides a means for making a more natural food product comprising less additional dry ingredients, which may provide undesired off-flavors and reduces cost production. Sixth, the method allows for the incorporation of a wide range of ingredients and nutritional supplements such that different micronutrient and mineral fortifications are possible and able to address a number of needed nutrients to undernourished populations as well as children. Nutritional density is increased due to the use of the whole bean (vs. the removal of various fractions during processing). Finally, the method provides for a simplified and cost-efficient process that can be easily re-produced.

Unless otherwise indicated, all numbers expressing quantities of ingredients are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

While this invention has been particularly shown and described with reference to a preferred embodiment, it will be understood by those skilled in the art that various changes in form and detail may be made therein without departing from the spirit and scope of the invention.

What is claimed is:

1. A method for making a dough comprised of whole, raw legumes, said method comprising the steps of:
a) pressure cooking a plurality of whole, unprocessed legumes, wherein said legumes comprise a native moisture content of between about 19% to about 45% protein on a dry weight basis;
b) grinding said legumes, wherein said cooked and ground legumes comprise a moisture content of between about 42% to about 49%; and
c) mixing said legumes with other dry ingredients.

2. The method of claim 1 further comprising the step of:
d) hydrating the legumes with additional water.

3. The method of claim 1 further comprising the step of:
d) forming said dough.

4. The method of claim 3 further comprising the step of:
e) cooking said formed dough, thereby creating a legume-based snack.

5. The method of claim 1 further comprising the step of:
d) subjecting the legumes to a low thermal stress dewatering at temperatures below about 160° F.

6. The method of claim 5 wherein said low thermal stress dewatering comprises centrifugation.

7. The method of claim 5 wherein said low thermal stress dewatering comprises microwave drying.

8. The method of claim 1, wherein said dry ingredients are selected from one or more of the group consisting of corn, starch, oats and orange juice pulp.

9. The method of claim 1 wherein said legumes are soybeans.

10. The method of claim 1 wherein said legumes are chickpeas.

11. The method of claim 1 wherein said dry ingredients comprise a protein ingredient.

12. The method of claim 4, wherein said cooking step comprises frying.

13. The method of claim 4, wherein said cooking step comprises baking.

14. The method of claim 1 further comprising a seasoning step.

15. The method of claim 3 wherein said forming step comprises sheeting.

16. The method of claim 1 wherein said dry ingredients comprise one or more of the group consisting of fiber, whole grains, fruits, nuts, and mixtures thereof.

17. The method of claim 1 wherein said dry ingredients are selected from byproducts of other processes.

18. The method of claim 4 wherein said legume-based snack comprises at least 5 grams of protein.

19. A legume-based snack product made from the method of claim 4.

20. A legume-based dough made from the method of claim 2.
